(19) United States
(12) Patent Application Publication
(10) Pub. No.: US 2007/0286054 A1
(43) Pub. Date: Dec. 13, 2007

(54) OBJECTIVE LENS FOR OPTICAL INFORMATION RECORDING/REPRODUCING DEVICE

(75) Inventors: Tomokazu KOIZUMI, Saitama (JP); Shuichi TAKEUCHI, Saitama (JP); Daisuke KOREEDA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/762,096

(22) Filed: Jun. 13, 2007

(30) Foreign Application Priority Data
Jun. 13, 2006 (JP) 2006-163367

(51) Int. Cl. G11B 7/00

(52) U.S. Cl. 369/112.25; 369/112.05

(57) ABSTRACT

An objective lens for an optical information recording/reproducing device (executing information reading or writing on first through third optical discs having different data densities and different protective layer thicknesses t1-t3 (t1≦t2≦t3)) by selectively using first through third substantially collimated light beams having first through third wavelengths λ1-λ3 (λ1<λ2<λ3) respectively) includes a first optical member and a second optical member which are cemented together at a cementing surface. At least an area of the cementing surface within an incidence height necessary for securing a numerical aperture NA3 (required for the information read/write on the third optical disc) is provided with a diffracting structure including annular zones. The diffracting structure is formed so that diffraction orders m(λ1), m(λ2) and m(λ3) of the first through third light beams maximizing their diffraction efficiency satisfy m(λ1)>m(λ2)≧m(λ3)≧1.

### BACKGROUND OF THE INVENTION

The present invention relates to an objective lens which is installed in a device employing multiple types of light beams having different wavelengths, such as an optical information recording/reproducing device for reading or writing information from/to multiple types of optical discs differing in data density.

There exist various standards of optical discs (CD, DVD, etc.) differing in data density, protective layer thickness, etc. Meanwhile, new-standard optical discs (HD DVD (High-Definition DVD), BD (Blu-ray Disc), etc.), having still higher data density than DVD, are being brought into practical use in recent years to realize still higher information storage capacity. The protective layer thickness of such a new-standard optical disc is substantially equal to or less than that of DVD. In consideration of user convenience with such optical discs according to multiple standards, the optical information recording/reproducing devices (more specifically, objective lenses installed in the devices) of recent years are required to have compatibility with the above three types of optical discs. Incidentally, in this specification, the “optical information recording/reproducing devices” include devices for both information reading and information writing, devices exclusively for information reading, and devices exclusively for information writing. The above “compatibility” means that the optical information recording/reproducing device ensures the information reading and/or information writing with no need of component replacement even when the optical disc being used is switched.

In order to provide an optical information recording/reproducing device with the compatibility with optical discs of multiple standards, the device has to be configured to be capable of forming a beam spot suitable for the particular data density of the new disc (in the switching of the optical disc to the new disc of a different standard) by changing a NA (Numerical Aperture) of the light beam employed for the information read/write, while also correcting spherical aberration which varies depending on the protective layer thickness. Since the diameter of the beam spot can generally be made smaller as the wavelength of the beam gets shorter, multiple laser beams having different wavelengths are selectively used by the optical information recording/reproducing device depending on the data density of the disc. For example, for DVDs, a laser beam with a wavelength of approximately 660 nm (shorter than approximately 790 nm for CDs) is used. For the aforementioned new-standard optical discs, a laser beam with a wavelength still shorter than that for DVDs (e.g. so-called “blue laser” around 408 nm) is used in order to deal with the extra-high data density.

Meanwhile, in order to finely converge each light beam exactly at the read/write position on the record surface of the corresponding optical disc, a technique, forming an “annular zone structure” (including a plurality of concentric annular zones with a minute level difference between adjacent zones) on an arbitrary-selected surface of the objective lens and finely converging light beams of different wavelengths on the record surfaces of the corresponding optical discs respectively by the effect of the annular zone structure, has been brought into practical use.

An objective lens having the compatibility with three types of optical discs (e.g. CD, DVD and HD DVD) as above has been proposed in Japanese Patent Provisional Publication No. 2004-362626 (hereinafter referred to as a “document #1”), for example.

In the objective lens described in the document #1, in order to achieve the compatibility with three types of optical discs having different data densities, spherical aberration of two types of light beams having first and second wavelengths (out of the three types of light beams having first through third wavelengths, respectively) is corrected by use of a diffracting structure formed on the objective lens, while correcting spherical aberration of the other light beam (having the third wavelength) by controlling the degree of divergence of the light beam incident upon the objective lens.

In such cases where a diverging beam is incident upon the objective lens, aberration (e.g. coma aberration) occurs during the tracking of the objective lens. Such aberration has significant ill effects on the information read/write especially when an optical disc of high data density (requiring a high NA for the information read/write) is used. However, in order to try to use a collimated beam (incident upon the objective lens) for each of the optical discs in the configuration described in the document #1, the diffracting structure has to be modified to a more complicated, minute and precise structure.

Meanwhile, techniques for achieving the compatibility with three types of optical discs while letting a collimated beam incident upon the objective lens have been proposed in Japanese Patent Provisional Publication No. 2005-100586 (hereinafter referred to as a “document #2”), Japanese Patent Provisional Publication No. 2006-012394 (hereinafter referred to as a “document #3”) and Japanese Patent Provisional Publication No. 2006-012393 (hereinafter referred to as a “document #4”).

In the documents #2 and #3, techniques for satisfying the compatibility with three types of optical discs while preventing deterioration of diffraction efficiency in an objective optical system including a cementing surface, by providing the cementing surface with a diffracting structure having no aberration correcting function for the so-called blue laser beam while correcting aberration of the other two light beams of longer wavelengths, have been proposed. In the patent document #4, a technique for achieving high diffraction efficiency in an optical system including a cementing surface (similarly to the other patent documents), by setting a refractive index difference between two materials (which are cemented together at the cementing surface) for each of the light beams used for CD and DVD larger than the refractive index difference for the so-called blue laser beam, has been proposed.

In consideration of the easiness of the formation of the diffracting structure at the cementing surface, it is desirable that both of the two optical members (which are cemented together) be made of resin. However, there are very few existing optical materials suitable for the configurations described in the patent documents #2-#4 and it is difficult to properly select a suitable combination of resins from existing optical materials.

### SUMMARY OF THE INVENTION

The present invention is advantageous in that an objective lens for an optical information recording/reproducing device (which executes information reading or writing on three types of optical discs of different standards by selectively using multiple light beams having different wavelengths), capable of forming a desirable beam spot on the record surface of each optical disc while reducing various aberrations (e.g. spherical aberration) irrespective of which of the three types of optical discs is used, realizing high-accuracy information read/write while securing high diffraction efficiency irrespective of which of the three types of optical discs is used, and allowing the selection of a suitable combination of the materials (of the optical members of the objective lens which are cemented together) facilitating the manufacturing process of the objective lens while also allowing for a high degree of freedom of material selection, can be provided.

In accordance with an aspect of the present invention, there is provided an objective lens for an optical information recording/reproducing device which executes information reading or writing on multiple types of optical discs having different data densities by selectively using first through third substantially collimated light beams having first through third wavelengths λ1-λ3 (λ1<λ2<λ3) respectively. A protective layer thickness t1 of a first optical disc on which the information read/write is executed using the first light beam, a protective layer thickness t2 of a second optical disc on which the information read/write is executed using the second light beam, and a protective layer thickness t3 of a third optical disc on which the information read/write is executed using the third light beam satisfy t1≦t2<t3. A numerical aperture NA1 required for the information read/write on the first optical disc, a numerical aperture NA2 required for the information read/write on the second optical disc, and a numerical aperture NA3 required for the information read/write on the third optical disc satisfy NA1>NA3 and NA2>NA3. The objective lens includes a first optical member and a second optical member which are cemented together at a cementing surface. At least an area of the cementing surface within an incidence height necessary for securing the numerical aperture NA3 is provided with a diffracting structure including annular zones. The diffracting structure is formed so that diffraction orders m(λ1), m(λ2) and m(λ3) of the first through third light beams maximizing their diffraction efficiency satisfy m(λ1)>m(λ2)≧m(λ3)≧1.

With the objective lens for an optical information recording/reproducing device configured as above, the diffraction efficiency of the light beams can be increased by use of a cemented lens having a diffracting structure at its cementing surface, compared to cases where a diffracting structure is formed at an interface of the objective lens to air. Further, by setting the diffraction order of the diffracting structure for a short-wavelength light beam larger than that for a long-wavelength light beam, high performance (light utilization efficiency, etc.) can be achieved while maintaining higher degree of freedom of material selection compared to cemented diffracting lenses which have been proposed. Therefore, high diffraction efficiency can be achieved irrespective of which of the first through third optical discs is used, by properly selecting the materials according to ratio among the diffraction orders of the incident light beams (first through third light beams) maximizing their diffraction efficiency. Furthermore, since a substantially collimated light beam is used for each of the first through third optical discs, the aforementioned aberration occurring during tracking shifts can be reduced and a beam spot suitable for the information read/write can be formed on the record surface of each optical disc.

In at least one aspect, the ratio among the diffraction orders of the first through third light beams maximizing their diffraction efficiency is set at 3:2:2.

When the above configuration is employed, it is preferable that the first and second optical members be configured to satisfy the following conditions (1) and (2):

1.00≦Δn(λ2)/Δn(λ1)≦1.18 (1)

1.02≦Δn(λ3)/Δn(λ1)≦1.30 (2)

where:

Δn(λ1)=n2(λ1)−n1(λ1),

Δn(λ2)=n2(λ2)−n1(λ2),

Δn(λ3)=n2(λ3)−n1(λ3),
n1(λi) denotes a refractive index of the first optical member at the i-th wavelength, and
n2(λi) denotes a refractive index of the second optical member at the i-th wavelength.

Optionally, the ratio among the diffraction orders of the first through third light beams maximizing their diffraction efficiency is set at 5:3:3.

When the above configuration is employed, it is preferable that the first and second optical members be configured to satisfy the following conditions (3) and (4):

0.85≦Δn(λ2)/Δn(λ1)≦1.10 (3)

0.88≦Δn(λ3)/Δn(λ1)≦1.25 (4)

where:

Δn(λ1)=n2(λ1)−n1(λ1),

Δn(λ2)=n2(λ2)−n1(λ2),

Δn(λ3)=n2(λ3)−n1(λ3),
n1(λi) denotes a refractive index of the first optical member at the i-th wavelength, and
n2(λi) denotes a refractive index of the second optical member at the i-th wavelength.

As above, by the selection of a proper ratio among the diffraction orders of the first through third light beams maximizing their diffraction efficiency, material selection from a wide range of materials becomes possible while also achieving high diffraction efficiency of the light beams.

In at least one aspect, the first and second optical members are configured to satisfy the following condition (5):

0.01≦|Δn(λ1)|≦0.15 (5)

where:

Δn(λ1)=n2(λ1)−n1(λ1),
n1(λi) denotes a refractive index of the first optical member at the first wavelength, and
n2(λi) denotes a refractive index of the second optical member at the first wavelength.

When the value of the condition (5) goes below the lower limit, each level difference formed in the diffracting structure becomes too deep. On the other hand, when the value of the condition (5) goes over the upper limit, the amount of aberration occurring due to a shape error, etc. of the cementing surface becomes excessive. To sum up, the first and second optical members not satisfying the above condition (5) are undesirable since the manufacture of the objective lens achieving the desired performance becomes difficult.

In at least one aspect, both of the first and second optical members are made of resin.

The diffracting structure can be formed relatively with ease by using resin for the first and second optical members.

In at least one aspect, at least one optical surface of the objective lens other than the cementing surface is provided with a diffracting structure in its area outside the incidence height necessary for securing the numerical aperture NA3.

In the area outside the incidence height necessary for securing the numerical aperture NA3 (of the third light beam requiring the smallest numerical aperture among the first through third light beams), the diffraction efficiency of the third light beam (having the third wavelength) is not necessarily required to be high. In the outer area, it is desirable to diverge or disperse the third light beam as an unnecessary beam by forming a diffracting structure on an optical surface other than the cementing surface.

In at least one aspect, the diffracting structure is configured so that the diffraction order m(λ1) of the first light beam maximizing its diffraction efficiency is set at an odd order.

With this configuration (with the ratio among the diffraction orders set at 3:2:2, 5:3:3, etc.), an aperture restricting function for the third light beam can be achieved while also reducing changes in the spherical aberration of the first and second light beams caused by temperature variation.

### BRIEF DESCRIPTION OF THE ACCOMPANYING DRAWINGS

FIG. 1 is a schematic diagram showing the overall composition of an optical information recording/reproducing device which is equipped with an objective lens in accordance with an embodiment of the present invention.

FIGS. 2A-2C are schematic diagrams showing the relationship among the objective lens, an optical disc and the optical path of a laser beam in cases where first through third optical discs are used.

FIG. 3 is a schematic cross-sectional view of the objective lens of the embodiment.

FIG. 4 is an aberration diagram showing spherical aberration occurring when each of the first through third optical discs (first through third laser beams) is used in the optical information recording/reproducing device of a third example of the embodiment.

FIG. 5 is an aberration diagram showing spherical aberration occurring when each of the first through third optical discs (first through third laser beams) is used in the optical information recording/reproducing device of a fourth example of the embodiment.

### DETAILED DESCRIPTION OF THE EMBODIMENTS

Referring now to the drawings, a description will be given in detail of a preferred embodiment in accordance with the present invention.

In the following, an objective lens in accordance with an embodiment of the present invention will be described. The objective lens of this embodiment, which is installed in an optical information recording/reproducing device, has the compatibility with three types of optical discs according to different standards (protective layer thickness, data density, etc.).

In the following explanation, an optical disc of a type (one of the three types) having the highest data density (e.g. new-standard optical disc such as HD DVD, DVD or BD) will be referred to as a “first optical disc D1”, an optical disc of a type having a relatively low data density compared to the first optical disc D1 (DVD, DVD-R, etc.) will be referred to as a “second optical disc D2”, and an optical disc of a type having the lowest data density (CD, CD-R, etc.) will be referred to as a “third optical disc D3” for convenience of explanation.

The protective layer thicknesses t1-t3 of the first through third optical discs D1-D3 satisfy the following relationship:

t1≦t2<t3

In order to carry out the information read/rite on each of the optical discs D1-D3, the NA (Numerical Aperture) required for the information read/write has to be varied properly so that a beam spot suitable for the particular data density of each disc can be formed. The optimum design NAs required for the information read/write on the three types of optical discs D1, D2 and D3 (hereinafter described as “NA1”, “NA2” and “NA3”) satisfy the following relationships:

(NA1>NA3) and (NA2>NA3)

Specifically, for the information read/write on the first or second optical disc D1, D2 (having high data density), a relatively large NA is required since a relatively small spot has to be formed. On the other hand, for the information read/write on the third optical disc D3 (having the lowest data density), the required NA is relatively small. Incidentally, each optical disc is set on an unshown turntable and rotated at high speed when the information read/write is carried out.

In cases where three types of optical discs D1-D3 (having different data densities) are used as above, multiple laser beams having different wavelengths are selectively used by the optical information recording/reproducing device so that a beam spot suitable for each data density can be formed on the record surface. Specifically, for the information read/write on the first optical disc D1, a “first laser beam” having the shortest wavelength (first wavelength) is emitted from a light source so as to form the smallest beam spot on the record surface of the first optical disc D1. On the other hand, for the information read/write on the third optical disc D3, a “third laser beam” having the longest wavelength (third wavelength) is emitted from a light source so as to form the largest beam spot on the record surface of the third optical disc D3. For the information read/write on the second optical disc D2, a “second laser beam” having a wavelength longer than that of the first laser beam and shorter than that of the third laser beam (second wavelength) is emitted from a light source so as to form a relatively small beam spot on the record surface of the second optical disc D2.

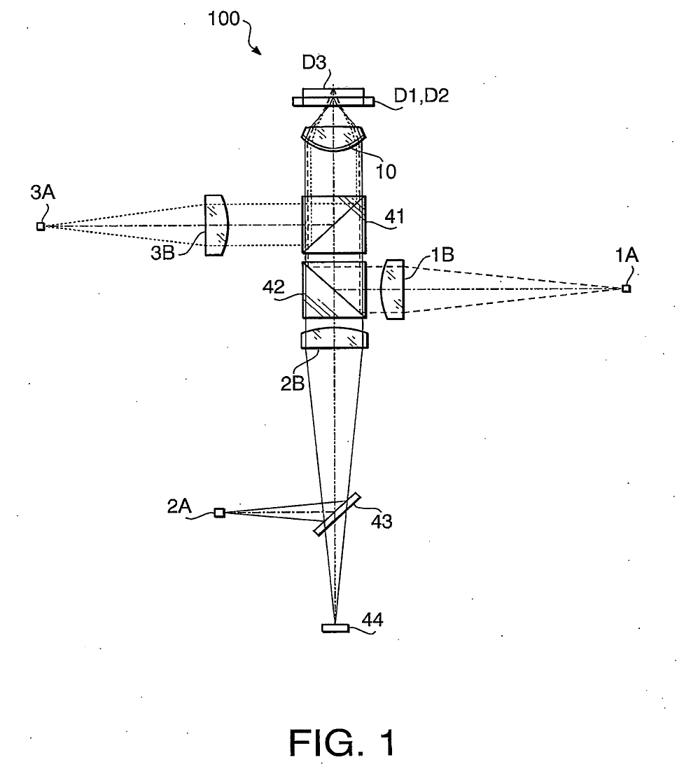

FIG. 1 is a schematic diagram showing the overall composition of an optical information recording/reproducing device 100 which is equipped with the objective lens 10 of this embodiment. The optical information recording/reproducing device 100 includes a light source 1A which emits the first laser beam, a light source 2A which emits the second laser beam, a light source 3A which emits the third laser beam, coupling lenses 1B, 2B and 3B, beam splitters 41 and 42, a half mirror 43, and a photoreceptor unit 44. Incidentally, since the optical information recording/reproducing device 100 has to support various NAs required for the information read/write on various optical discs, an aperture restricting element for specifying the beam diameter of the third laser beam may also be placed on the optical path of the third laser beam between the light source 3A and the objective lens 10 (although not shown in FIG. 1).

As shown in FIG. 1, each laser beam (first laser beam, second laser beam, third laser beam) emitted by the corresponding light source (1A, 2A, 3A) is transformed by each coupling lens (1B, 2B, 3B) into a collimated beam. Thus, each coupling lens 1B-3B functions as a collimator lens in this embodiment. Each laser beam passing through the coupling lens (1B, 2B, 3B) is guided to a common optical path by the beam splitters 41 and 42 and thereafter enters the objective lens 10. Each beam passing through the objective lens 10 is converged on a point in the vicinity of the record surface of the optical disc (D1, D2, D3) as the target of the information read/write. After being reflected by the record surface, each laser beam is detected by the photoreceptor unit 44 via the half mirror 43.

By letting each coupling lens 1B-3B transform each laser beam (to be incident upon the objective lens 10) into a collimated beam as above, off-axis aberration occurring during the tracking of the objective lens 10 (e.g. coma aberration) can be suppressed.

Incidentally, there are cases where each light beam emerging from each coupling lens 1B-3B is not necessarily a collimated beam in a strict sense, due to various factors such as individual differences and installation positions of the light sources 1A-3A, variations in the environment around the optical information recording/reproducing device 100, etc. However, the divergence angle of the light beam caused by the above factors is extremely small and the aberration occurring during the tracking shifts can also be regarded to be small, by which substantially no problem is caused in practical use.

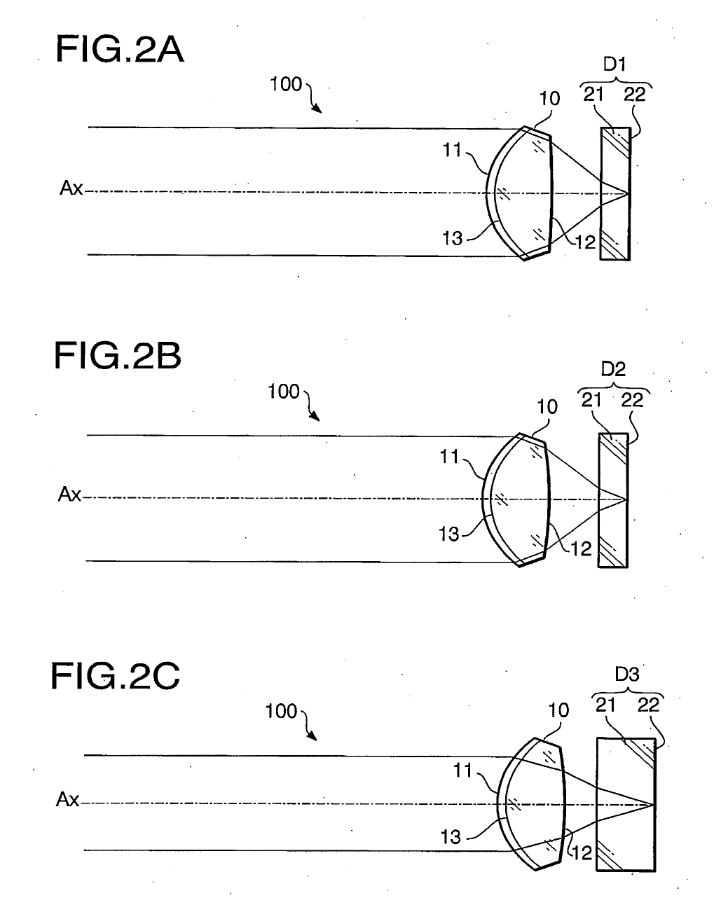

FIGS. 2A-2C are schematic diagrams showing the relationship among the objective lens 10, the optical disc (D1-D3) and the optical path of the laser beam (first laser beam, second laser beam, third laser beam) in cases where the first through third optical discs D1-D3 are used, respectively. In each of FIGS. 2A-2C, a reference axis AX of the optical system of the optical information recording/reproducing device 100 is indicated by a chain line. Incidentally, while the optical axis of the objective lens coincides with the reference axis AX of the optical system in the state shown in FIGS. 2A-2C, the optical axis of the objective lens can deviate from the reference axis AX due to the tracking operation, etc.

As shown in FIGS. 2A-2C, each optical disc D1-D3 has a protective layer 21 and a record surface 22. Incidentally, the record surface 22 is sandwiched between the protective layer 21 and a label layer (unshown) in actual optical discs D1-D3.

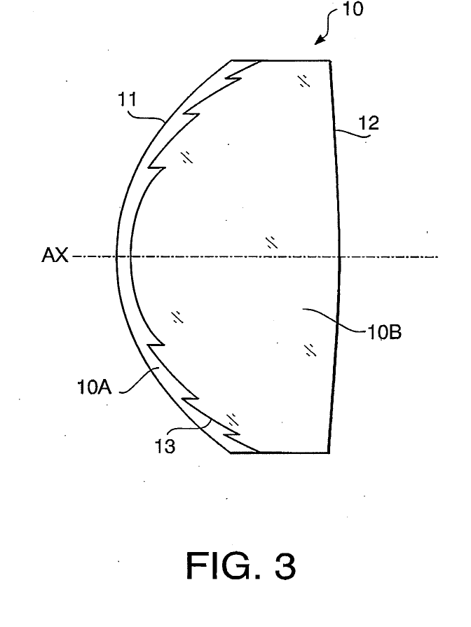

FIG. 3 is a schematic cross-sectional view of the objective lens 10. As shown in FIG. 3, the objective lens 10 is formed by cementing two optical members 10A and 10B (made of different materials) together at a cementing surface 13. The objective lens 10 formed by the cementing has a first surface 11 (on the light source side) and a second surface 12. The objective lens 10 is a biconvex cemented lens made of plastic whose first and second surfaces 11 and 12 are both aspherical and whose cementing surface 13 is a diffracting surface. The configuration of each aspherical surface can be expressed by the following expression:

$$X ( h ) = \frac{{Ch}^{2}}{1 + \sqrt{1 - ( K + 1 ) {C}^{2} {h}^{2}}} + {\sum }_{i = 2} {A}_{2 i} {h}^{2 i}$$

where X(h) denotes a SAG amount of a coordinate point on the aspherical surface whose height (distance) from the optical axis is h (SAG amount: distance measured from a tangential plane contacting the aspherical surface on the optical axis), “C” denotes the curvature (1/r) of the aspherical surface on the optical axis, “K” denotes a cone constant, and each “A₂ᵢ” (i: integer larger than 1) denotes an aspherical coefficient of the 2i-th order (the summation in the expression includes aspherical coefficients A₄, A₆, A₈, A₁₀, A₁₂, . . . of the fourth order, sixth order, eighth order, tenth order, twelfth order, and so forth).

In cases where multiple laser beams of different wavelengths are used for various optical discs D1-D3 as in the optical information recording/reproducing device 100 of this embodiment, spherical aberration occurs due to variations in the refractive index of the objective lens 10, the thickness of the protective layer 21, etc. (which vary depending on which optical disc is used).

Therefore, in order to correct the spherical aberration (occurring in different ways when the three types of optical discs D1-D3 are used) and achieve the compatibility with the optical discs D1-D3, at least the cementing surface 13 of the objective lens 10 of this embodiment is provided with a diffracting structure having diffracting effects on the three types of light beams. The diffracting structure formed at the cementing surface 13 includes a plurality of concentric refracting surfaces (annular zones) around the optical axis AX and a plurality of minute level differences each of which is formed between adjacent refracting surfaces.

The objective lens 10 of this embodiment has the function of converging the first through third laser beams on the record surfaces of the corresponding optical discs (D1, D2, D3) respectively while correcting the spherical aberration to approximately 0 by the diffracting effect and refracting effect of the cementing surface 13 and refracting effects of the first and second surfaces 11 and 12.

The configuration of the diffracting structure (cementing surface 13) of the objective lens 10 of this embodiment is specified by an optical path difference function which will be explained below. The optical path difference function represents the function of the objective lens 10 as a diffracting lens, in terms of an optical path length addition at each height h from the optical axis. The optical path difference function φ(h) can be expressed by the following expression:

$$φ ( h ) = m λ {\sum }_{i = 1} {P}_{2 i} {h}^{2 i}$$

In the above optical path difference function φ(h), each “P₂ᵢ” (i: positive integer) denotes a coefficient of the 2i-th order (the summation in the expression includes coefficients P₂, P₄, P₆, . . . of the second order, fourth order, sixth order, and so forth), “m” denotes the diffraction order maximizing the diffraction efficiency of the laser beam being used, and “λ” denotes the design wavelength of the laser beam being used. In this embodiment, the diffraction orders “m” of the first through third laser beams maximizing their diffraction efficiency satisfies the following condition:

m(λ1)>m(λ2)≧m(λ3)≧1

where m(λ1) denotes the diffraction order of the first laser beam (having the first wavelength) maximizing its diffraction efficiency, m(λ2) denotes the diffraction order of the second laser beam (having the second wavelength) maximizing its diffraction efficiency, and m(λ3) denotes the diffraction order of the third laser beam (having the third wavelength) maximizing its diffraction efficiency. By setting the diffraction orders of the first through third laser beams, high performance (light utilization efficiency, etc.) can be achieved while maintaining higher degree of freedom of material selection compared to cemented diffracting lenses which have been proposed.

Each optical member (10A, 10B) forming the objective lens 10 is made of material that is specified by a particular ratio among diffraction orders (of the first through third laser beams) maximizing diffraction efficiency of each of the laser beams employed (hereinafter simply referred to as “the ratio among the diffraction orders”) so that high “light utilization efficiency” can be achieved irrespective of which of the first through third laser beams is incident upon the objective lens 10.

In the following, the selection of the materials of the optical members 10A and 10B suitable for two configuration examples of the objective lens 10 (first configuration example having a ratio of 3:2:2, second configuration example having a ratio of 5:3:3) will be described in detail. In the first configuration example, a diffracting structure whose ratio among the diffraction orders is 3:2:2 (listed from the diffraction order of the first laser beam) is formed at the cementing surface 13 of the objective lens 10. In the second configuration example, a diffracting structure whose ratio among the diffraction orders is 5:3:3 is formed at the cementing surface 13 of the objective lens 10.

As the materials of the optical members 10A and 10B forming the objective lens 10 of the first configuration example, those satisfying the following conditions (1) and (2) are selected:

1.00≦Δn(λ2)/Δn(λ1)≦1.18 (1)

1.02≦Δn(λ3)/Δn(λ1)≦1.30 (2)

where:

Δn(λ1)=n2(λ1)−n1(λ1),

Δn(λ2)=n2(λ2)−n1(λ2),

Δn(λ3)=n2(λ3)−n1(λ3),
n1(λi) denotes the refractive index of the first optical member 10A at the i-th wavelength, and
n2(λi) denotes the refractive index of the second optical member 10B at the i-th wavelength.

The conditions (1) and (2) are those for achieving relatively high light utilization efficiency in the use of the second or third optical disc (D2, D3) with reference to the light utilization efficiency in the use of the first optical disc D1. In the conditions (1) and (2), when the value (ratio) goes below the lower limit or over the upper limit, the light utilization efficiency in the use of each optical disc gets too low and stray light deriving from diffracted beams of unnecessary orders becomes a problem.

In the second configuration example, materials satisfying the following conditions (3) and (4) are selected for the first and second optical members 10A and 10B of the objective lens 10:

0.85≦Δn(λ2)/Δn(λ1)≦1.10 (3)

0.88≦Δn(λ3)/Δn(λ1)≦1.25 (4)

The upper and lower limits in the above conditions (3) and (4) are set for the objective lens 10 of the second configuration example to let it achieve effects similar to those of the objective lens 10 of the first configuration example satisfying the conditions (1) and (2).

Both in the first and second configuration examples, the materials of the first and second optical members 10A and 10B are selected to satisfy the following condition (5):

0.01≦|Δn(λ1)|≦0.15 (5)

The above condition (5) is related to whether the cementing surface 13 can be formed with ease or not. The depth At of the diffracting level difference in the optical axis direction is given by the following expression:

Δt=m·λ/Δn(λ) (6)

where “λ” and “m” denote the wavelength and diffraction order maximizing the diffraction efficiency and Δn(λ) denotes the difference between the refractive indexes of the first and second optical members 10A and 10B at the wavelength λ.

Specifically, the level difference becomes extremely deep when Δn(λ) is too small since the depth Δt of the level difference is inversely proportional to Δn(λ). Therefore, the first and second optical members 10A and 10B are required to have a refractive index difference Δn(λ) not less than the lower limit of the condition (5). On the other hand, if the refractive index difference Δn(λ) becomes too large, the amount of aberration occurring at the cementing surface 13 becomes excessive, by which permissible ranges of shape error and decentering of the cementing surface 13 become extremely narrow. Thus, the materials of the first and second optical members 10A and 10B are selected so as not to exceed the upper limit of the condition (5).

In the following, four specific examples of the objective lens 10 of this embodiment explained above will be described.

In the following examples, a first optical disc D1 having the highest data density and a protective layer thickness of 0.6 mm, a second optical disc D2 having a data density lower than that of the first optical disc D1 and a protective layer thickness of 0.6 mm, and a third optical disc D3 having the lowest data density and a protective layer thickness of 1.2 mm are assumed to be used.

### FIRST EXAMPLE

The overall configuration of the objective lens 10 as a first example is shown in FIG. 3. The cementing surface 13 of the objective lens 10 of the first example is provided with a diffracting structure designed so that the ratio among the diffraction orders of the first through third laser beams maximizing their diffraction efficiency will be 3:2:2 (according to the aforementioned first configuration example). The following Table 1 shows the refractive indexes of the first and second optical members 10A and 10B (forming the objective lens 10 of the first example having such a diffracting structure) for the first through third laser beams.

TABLE 1

| | 1^{ST} laser beam | 2^{nd} laser beam | 3^{rd} laser beam |
|---|---|---|---|
| wavelength (nm) | 405 | 660 | 790 |
| refractive index n1 | 1.57494 | 1.55670 | 1.55311 |
| refractive index n2 | 1.56023 | 1.54044 | 1.53653 |

According to Table 1, the values of the conditions (1), (2) and (5) of the objective lens 10 of the first example are 1.105, 1.127 and 0.015, respectively. Thus, the objective lens 10 of the first example satisfies all the conditions (1), (2) and (5). With this configuration, diffraction efficiency of 100% can be secured for the first and second laser beams as well as securing diffraction efficiency of 79% for the third laser beam. As above, the objective lens 10 of the first example is capable of securing high light utilization efficiency irrespective of which of the optical discs D1-D3 is used.

### SECOND EXAMPLE

The overall configuration of the objective lens 10 as a second example is also shown in FIG. 3. The cementing surface 13 of the objective lens 10 of the second example is provided with a diffracting structure designed so that the ratio among the diffraction orders of the first through third laser beams maximizing their diffraction efficiency will be 5:3:3 (according to the aforementioned second configuration example). The following Table 2 shows the refractive indexes of the first and second optical members 10A and 10B (forming the objective lens 10 of the second example having such a diffracting structure) for the first through third laser beams.

TABLE 2

| | 1^{ST} laser beam | 2^{nd} laser beam | 3^{rd} laser beam |
|---|---|---|---|
| wavelength (nm) | 405 | 660 | 790 |
| refractive index n1 | 1.58374 | 1.56584 | 1.56228 |
| refractive index n2 | 1.56023 | 1.54044 | 1.53653 |

According to Table 2, the values of the conditions (3), (4) and (5) of the objective lens 10 of the second example are 1.080, 1.095 and 0.024, respectively. Thus, the objective lens 10 of the second example satisfies all the conditions (3), (4) and (5). With this configuration, diffraction efficiency of 100% can be secured for the first laser beam, 71% can be secured for the second laser beam, and 88% can be secured for the third laser beam. As above, similarly to the first example, the objective lens 10 of the second example is capable of securing high light utilization efficiency irrespective of which of the optical discs D1-D3 is used.

### THIRD EXAMPLE

A third example described below is a specific example of the optical information recording/reproducing device 100 equipped with the objective lens 10 of the embodiment. The overall configuration of the optical information recording/reproducing device 100 of the third example is shown in FIG. 1. The following Table 3 shows concrete specifications of the objective lens 10 of the optical information recording/reproducing device 100 of the third example.

TABLE 3

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.10 | 3.12 |
| NA | 0.65 | 0.63 | 0.51 |
| Magnification M | 0.000 | 0.000 | 0.000 |

As indicated by the “Maginfication M” in Table 3, the laser beam is incident upon the objective lens 10 as a collimated beam in the optical information recording/reproducing device 100 of the third example irrespective of which of the optical discs D1-D3 is used (i.e. irrespective of which of the first through third laser beams is used). The following Tables 4-6 show specific numerical configurations of the optical information recording/reproducing device 100 (equipped with the objective lens 10 having the specifications shown in Table 3) when each of the optical discs D1-D3 is used.

TABLE 4

| Surface No. | r | d | n(405 nm) | REMARKS |
|---|---|---|---|---|
| 0 | | ∞ | | Light Source |
| 1 | 1.980 | 0.10 | 1.53212 | Objective Lens |
| 2 | 1.407 | 2.20 | 1.56023 | |
| 3 | −7.176 | 1.36 | | |
| 4 | ∞ | 0.60 | 1.62231 | Optical Disc |
| 5 | ∞ | — | | |

TABLE 5

| Surface No. | r | d | n(660 nm) | REMARKS |
|---|---|---|---|---|
| 0 | | ∞ | | Light Source |
| 1 | 1.980 | 0.10 | 1.51073 | Objective Lens |
| 2 | 1.407 | 2.20 | 1.54044 | |
| 3 | −7.176 | 1.43 | | |
| 4 | ∞ | 0.60 | 1.57961 | Optical Disc |
| 5 | ∞ | — | | |

TABLE 6

| Surface No. | r | d | n(790 nm) | REMARKS |
|---|---|---|---|---|
| 0 | | ∞ | | Light Source |
| 1 | 1.980 | 0.10 | 1.50741 | Objective Lens |
| 2 | 1.407 | 2.20 | 1.53653 | |
| 3 | −7.176 | 1.07 | | |
| 4 | ∞ | 1.20 | 1.57307 | Optical Disc |
| 5 | ∞ | — | | |

In Tables 4-6, “r” denotes the curvature radius [mm] of each optical surface, “d” denotes the distance [mm] from each optical surface to the next optical surface during the information read/write, “n (X nm)” denotes the refractive index of a medium between each optical surface and the next optical surface for a wavelength of X nm (ditto for Tables 10, 11 and 12 explained later in the fourth example).

As shown in the “REMARKS” in Tables 4-6, the surface No. 0 represents the light source (1A-3A), the surface No. 1 represents the first surface 11 of the objective lens 10, the surface No. 2 represents the cementing surface 13 of the objective lens 10, the surface No. 3 represents the second surface 12 of the objective lens 10, the surface No. 4 represents the surface of the protective layer 21 of the optical disc (D1-D3) as the medium, and the surface No. 5 represents the record surface 22 of the optical disc (D1-D3). Incidentally, numerical configurations of optical members (elements) placed between each light source (1A-3A) and the objective lens 10 are omitted in Tables 4-6 for convenience of explanation.

The surfaces 11, 13 and 12 of the objective lens 10 (surfaces Nos. 1, 2 and 3) are aspherical surfaces. The following Table 7 shows the cone constant and aspherical coefficients specifying the shape of each aspherical surface (11, 13, 12). Incidentally, the notation “E” in Table 7, etc. means the power of 10 with an exponent specified by the number to the right of E (e.g. “E-04” means “×10⁻⁴”).

TABLE 7

| | K | A4 | A6 | A8 | A10 | A12 |
|---|---|---|---|---|---|---|
| 1 | −0.6800 | 6.9820E−04 | 3.6170E−03 | −2.4400E−03 | 7.3960E−04 | −8.1307E−05 |
| 2 | −0.6800 | 1.5010E−02 | −9.6920E−02 | 5.8340E−02 | −1.6570E−02 | 1.8814E−03 |
| 3 | 0.0000 | 2.3280E−02 | −7.7780E−03 | 4.6600E−03 | −1.9510E−03 | 2.6691E−04 |

The following Table 8 shows the coefficients P₂ᵢ (i: positive integer) of the optical path difference function specifying the diffracting structure formed at the cementing surface 13 of the objective lens 10 installed in the optical information recording/reproducing device 100 of the third example. The ratio among the diffraction orders of the first through third laser beams (incident upon the diffracting structure) maximizing their diffraction efficiency is 3:2:2 (according to the aforementioned first configuration example). Specifically, for the first and second optical members 10A and 10B forming the objective lens 10 of the optical information recording/reproducing device 100 of the third example, materials having refractive indexes shown in the above Tables 4-6 have been selected as those suitable for the diffracting structure achieving the above ratio 3:2:2.

TABLE 8

| | P2 | P4 | P6 | P8 | P10 | P12 |
|---|---|---|---|---|---|---|
| 2 | 0.0000E+00 | −9.6680E−01 | −4.7270E−01 | 1.0280E−01 | 0.0000E+00 | 0.0000E+00 |

According to Tables 4-6, the values of the conditions (1), (2) and (5) of the objective lens 10 of the optical information recording/reproducing device 100 of the third example are 1.057, 1.036 and 0.028, respectively. Thus, the objective lens 10 in the third example satisfies all the conditions (1), (2) and (5). With this configuration, diffraction efficiency of 100% can be secured for the first laser beam, 99% can be secured for the second laser beam, and 56% can be secured for the third laser beam. As above, the optical information recording/reproducing device 100 of the third example is capable of securing high light utilization efficiency irrespective of which of the optical discs D1-D3 is used.

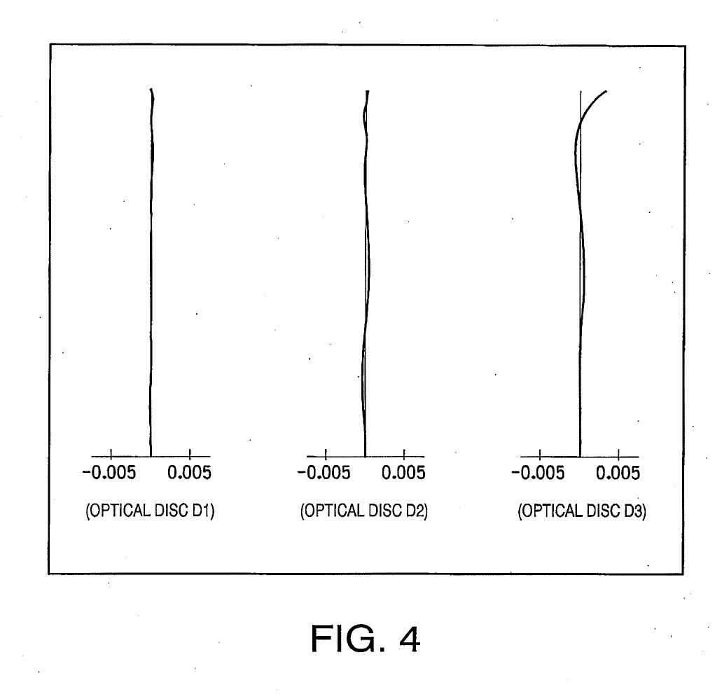

FIG. 4 is an aberration diagram showing the spherical aberration occurring when each of the optical discs D1-D3 is used in the optical information recording/reproducing device 100 of the third example. As shown in FIG. 4, the spherical aberration has been corrected excellently in the third example by the diffracting effect and aspherical effect of the cementing surface 13 irrespective of which of the optical discs D1-D3 is used, even though each laser beam is incident upon the objective lens 10 as a collimated beam (so-called “infinite system”).

### FOURTH EXAMPLE

A fourth example described below is another specific example of the optical information recording/reproducing device 100 equipped with the objective lens 10 of the embodiment. The overall configuration of the optical information recording/reproducing device 100 of the fourth example is also shown in FIG. 1. The following Table 9 shows concrete specifications of the objective lens 10 of the optical information recording/reproducing device 100 of the fourth example.

TABLE 9

| | 1^{st} laser beam | 2^{nd} laser beam | 3^{rd} laser beam |
|---|---|---|---|
| Wavelength (nm) | 405 | 660 | 790 |
| Focal Length (mm) | 3.00 | 3.10 | 3.12 |
| NA | 0.65 | 0.63 | 0.51 |
| Magnification M | 0.000 | 0.000 | 0.000 |

As indicated by the “MAGNIFICATION M” in Table 9, the laser beam is incident upon the objective lens 10 as a collimated beam in the optical information recording/reproducing device 100 of the fourth example irrespective of which of the optical discs D1-D3 is used (i.e. irrespective of which of the first through third laser beams is used), similarly to the third example. The following Tables 10-12 show specific numerical configurations of the optical information recording/reproducing device 100 (equipped with the objective lens 10 having the specifications shown in Table 9) when each of the optical discs D1-D3 is used.

TABLE 10

| Surface No. | r | d | n(405 nm) | REMARKS |
|---|---|---|---|---|
| 0 | | ∞ | | Light Source |
| 1 | 1.940 | 0.10 | 1.53212 | Objective Lens |
| 2 | 1.966 | 2.20 | 1.56023 | |
| 3 | −7.165 | 1.36 | | |
| 4 | ∞ | 0.60 | 1.62231 | Optical Disc |
| 5 | ∞ | — | | |

TABLE 11

| Surface No. | r | d | n(660 nm) | REMARKS |
|---|---|---|---|---|
| 0 | | ∞ | | Light Source |
| 1 | 1.940 | 0.10 | 1.51073 | Objective Lens |
| 2 | 1.966 | 2.20 | 1.54044 | |
| 3 | −7.165 | 1.44 | | |
| 4 | ∞ | 0.60 | 1.57961 | Optical Disc |
| 5 | ∞ | — | | |

TABLE 12

| Surface No. | r | d | n(790 nm) | REMARKS |
|---|---|---|---|---|
| 0 | | ∞ | | Light Source |
| 1 | 1.940 | 0.10 | 1.50741 | Objective Lens |
| 2 | 1.966 | 2.20 | 1.53653 | |
| 3 | −7.165 | 1.07 | | |
| 4 | ∞ | 1.20 | 1.57307 | Optical Disc |
| 5 | ∞ | — | | |

The surfaces 11, 13 and 12 of the objective lens 10 (surfaces Nos. 1, 2 and 3) are aspherical surfaces. The following Table 13 shows the cone constant and aspherical coefficients specifying the shape of each aspherical surface (11, 13, 12).

TABLE 13

| | K | A4 | A6 | A8 | A10 | A12 |
|---|---|---|---|---|---|---|
| 1 | −0.6800 | −6.1670E−04 | −3.1340E−04 | −3.0410E−05 | 6.1350E−05 | −1.5848E−05 |
| 2 | −0.6800 | 1.0620E−02 | 1.4140E−02 | 1.8410E−03 | −2.3870E−03 | 4.4342E−04 |
| 3 | 0.0000 | 2.3240E−02 | −2.8200E−03 | −1.1810E−03 | 2.6220E−04 | −8.3120E−06 |

The following Table 14 shows the coefficients P₂ᵢ (i: positive integer) of the optical path difference function specifying the diffracting structure formed at the cementing surface 13 of the objective lens 10 installed in the optical information recording/reproducing device 100 of the fourth example. The ratio among the diffraction orders of the first through third laser beams (incident upon the diffracting structure) maximizing their diffraction efficiency is 5:3:3 (according to the aforementioned second configuration example). Specifically, for the first and second optical members 10A and 10B forming the objective lens 10 of the optical information recording/reproducing device 100 of the fourth example, materials having refractive indexes shown in the above Tables 10-12 have been selected as those suitable for the diffracting structure achieving the above ratio 5:3:3.

TABLE 14

| | P2 | P4 | P6 | P8 | P10 | P12 |
|---|---|---|---|---|---|---|
| 2 | 0.0000E+00 | −9.5120E−01 | 8.5470E−02 | −8.1360E−02 | 0.0000E+00 | 0.0000E+00 |

According to Tables 10-12, the values of the conditions (3), (4) and (5) of the objective lens 10 of the optical information recording/reproducing device 100 of the fourth example are 1.057, 1.036 and 0.028, respectively. Thus, the objective lens 10 in the fourth example satisfies all the conditions (3), (4) and (5). With this configuration, diffraction efficiency of 100% can be secured for the first laser beam, 82% can be secured for the second laser beam, and 67% can be secured for the third laser beam. As above, the optical information recording/reproducing device 100 of the fourth example is capable of securing high light utilization efficiency irrespective of which of the optical discs D1-D3 is used.

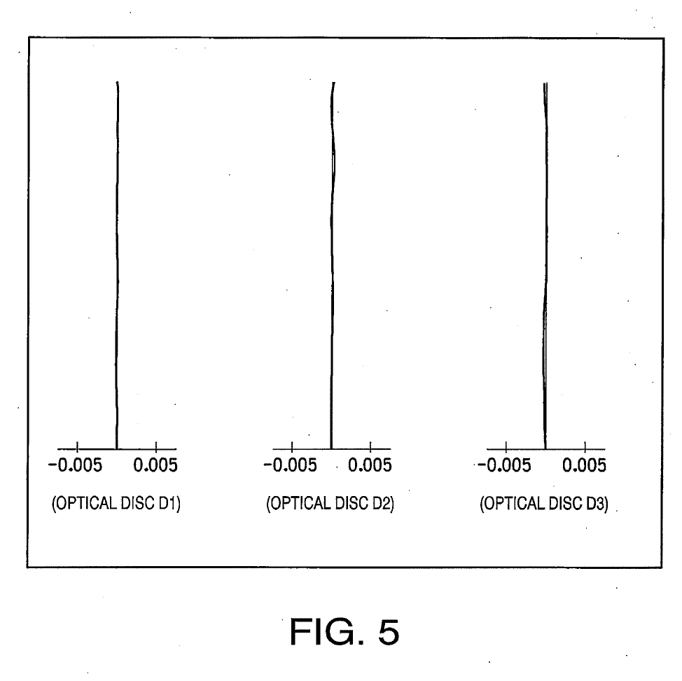

FIG. 5 is an aberration diagram showing the spherical aberration occurring when each of the optical discs D1-D3 is used in the optical information recording/reproducing device 100 of the fourth example. As shown in FIG. 5, the spherical aberration has been corrected excellently in the fourth example by the diffracting effect and aspherical effect of the cementing surface 13 irrespective of which of the optical discs D1-D3 is used, even though each laser beam is incident upon the objective lens 10 as a collimated beam (so-called “infinite system”).

As described above, the objective lens for an optical information recording/reproducing device in accordance with the embodiment of the present invention is configured by cementing two optical members (differing in optical performance) together to face each other at a cementing surface 13 provided with a prescribed diffracting structure. With this configuration, it becomes possible to secure high diffraction efficiency of the light beams and achieve information read/write with higher accuracy irrespective of which of the optical discs is used (especially, even when an optical disc of low data density (CD, etc.) is used). Further, a substantially collimated light beam can be used irrespective of which of the optical discs is used, by which not only the spherical aberration but also the aberration (e.g. coma aberration) occurring during the tracking shifts can be reduced excellently whether an existing optical disc or a new-standard optical disc is used.

By the selection of a proper ratio among the diffraction orders of the first through third light beams maximizing their diffraction efficiency (with each of the diffraction orders set at the first order or higher and the diffraction order of the first light beam (of the shortest wavelength) set higher than those of the other light beams), a wider range of material selection, a higher degree of freedom of the design, and a cemented lens with the first and second optical members made of resin (facilitating the formation of the diffracting structure) are made possible. Consequently, an objective lens for an optical information recording/reproducing device, capable of forming a desired beam spot (with a sufficient light amount) on the record surface of each of the three types of optical discs having different data densities, is provided.

While a description has been given above of a preferred embodiment in accordance with the present invention, the present invention is not to be restricted by the particular illustrative embodiment and a variety of modifications, design changes, etc. are possible without departing from the scope and spirit of the present invention described in the appended claims.

For example, the objective lens described in the above embodiment (including the specific examples) is just an illustration of an objective lens in accordance with the present invention. Therefore, the objective lens in accordance with the present invention is not to be restricted to the specific numerical configurations described in the above embodiment.

While the objective lens in the above embodiment has the diffracting structure at the cementing surface 13 only, it is also possible to provide another surface (e.g. first surface 11) with a diffracting structure having a different diffracting effect. The different diffracting effect can be an effect of suppressing variation in the spherical aberration caused by slight deviation of the wavelength of the laser beam emitted by the light source from the design wavelength, an effect of suppressing variation in the spherical aberration caused by temperature variation, an effect of diverging the third laser beam incident upon an area of the objective lens 10 outside the area corresponding to the numerical aperture NA3, etc. Incidentally, the above “design wavelength” means the wavelength of each laser beam which is regarded to be optimum for the information read/write on each optical disc.

This application claims priority of Japanese Patent Application No. P2006-163367, filed on Jun. 13, 2006. The entire subject matter of the application is incorporated herein by reference.

What is claimed is:

1. An objective lens for an optical information recording/reproducing device which executes information reading or writing on multiple types of optical discs having different data densities by selectively using first through third substantially collimated light beams having first through third wavelengths λ1-λ3 (λ1<λ2<λ3) respectively, wherein:
a protective layer thickness t1 of a first optical disc on which the information read/write is executed using the first light beam, a protective layer thickness t2 of a second optical disc on which the information read/write is executed using the second light beam, and a protective layer thickness t3 of a third optical disc on which the information read/write is executed using the third light beam satisfy t1≦t2<t3;
a numerical aperture NA1 required for the information read/write on the first optical disc, a numerical aperture NA2 required for the information read/write on the second optical disc, and a numerical aperture NA3 required for the information read/write on the third optical disc satisfy NA1>NA3 and NA2>NA3;
the objective lens includes a first optical member and a second optical member which are cemented together at a cementing surface;
at least an area of the cementing surface within an incidence height necessary for securing the numerical aperture NA3 is provided with a diffracting structure including annular zones; and
the diffracting structure is formed so that diffraction orders m(λ1), m(λ2) and m(λ3) of the first through third light beams maximizing their diffraction efficiency satisfy m(λ1)>m(λ2)≧m(λ3)≧1.

2. The objective lens according to claim 1, wherein ratio among the diffraction orders of the first through third light beams maximizing their diffraction efficiency is set at 3:2:2.

3. The objective lens according to claim 2, wherein the first and second optical members are configured to satisfy the following conditions (1) and (2):
1.00≦Δn(λ2)/Δn(λ1)≦1.18 (1)
1.02≦Δn(λ3)/Δn(λ1)≦1.30 (2)
where:
Δn(λ1)=n2(λ1)−n1(λ1),
Δn(λ2)=n2(λ2)−n1(λ2),
Δn(λ3)=n2(λ3)−n1(λ3),
n1(λi) denotes a refractive index of the first optical member at the i-th wavelength, and
n2(λi) denotes a refractive index of the second optical member at the i-th wavelength.

4. The objective lens according to claim 1, wherein ratio among the diffraction orders of the first through third light beams maximizing their diffraction efficiency is set at 5:3:3.

5. The objective lens according to claim 4, wherein the first and second optical members are configured to satisfy the following conditions (3) and (4):
0.85≦Δn(λ2)/Δn(λ1)≦1.10 (3)
0.88≦Δn(λ3)/Δn(λ1)≦1.25 (4)
where:
Δn(λ1)=n2(λ1)−n1(λ1),
Δn(λ2)=n2(λ2)−n1(λ2),
Δn(λ3)=n2(λ3)−n1(λ3),
n1(λi) denotes a refractive index of the first optical member at the i-th wavelength, and
n2(λi) denotes a refractive index of the second optical member at the i-th wavelength.

6. The objective lens according to claim 1, wherein the first and second optical members are configured to satisfy the following condition (5):
0.01≦|Δn(λ1)|≦0.15 (5)
where:
Δn(λ1)=n2(λ1)−n1(λ1),
n1(λ1) denotes a refractive index of the first optical member at the first wavelength, and
n2(λ1) denotes a refractive index of the second optical member at the first wavelength.

7. The objective lens according to claim 1, wherein both of the first and second optical members are made of resin.

8. The objective lens according to claim 1, wherein at least one optical surface of the objective lens other than the cementing surface is provided with a diffracting structure in its area outside the incidence height necessary for securing the numerical aperture NA3.

9. The objective lens according to claim 8, wherein the diffracting structure is configured so that the diffraction order m(λ1) of the first light beam maximizing its diffraction efficiency is set at an odd order.
